(19) United States
(12) Patent Application Publication
(10) Pub. No.: US 2025/0304776 A1
(43) Pub. Date: Oct. 2, 2025

(54) RUBBER COMPOSITION AND CONVEYOR BELT

(71) Applicant: THE YOKOHAMA RUBBER CO., LTD., HIRATSUKA-SHI (JP)

(72) Inventor: Ryosuke MATOBA, HIRATSUKA SHI (JP)

(21) Appl. No.: 18/958,531

(22) Filed: Nov. 25, 2024

(30) Foreign Application Priority Data
Mar. 29, 2024 (JP) 2024-057187

(51) Int. Cl. C08L 9/00; C08K 3/04; C08K 3/22; C08K 5/31; C08K 5/44

(52) U.S. Cl. CPC C08L 9/00; C08K 3/04; C08K 3/2279; C08K 5/31; C08K 5/44; C08K 2201/006

(57) ABSTRACT

A rubber composition containing: a diene rubber containing a natural rubber and a butadiene rubber; a flame retardant containing a chlorinated paraffin and antimony trioxide; carbon black; sulfur; a sulfenamide-based vulcanization accelerator and a guanidine-based vulcanization accelerator; a content of the natural rubber being from 20 to 50 mass % with respect to a total amount of the diene rubber; a content of the butadiene rubber being from 50 to 80 mass %; a content of the chlorinated paraffin being from 20 to 35 parts by mass per 100 parts by mass of the diene rubber; a content of the antimony trioxide being from 5 to 12 parts by mass; a mass ratio of the vulcanization accelerators/the sulfur being ≥1.00; and a mass ratio of the guanidine-based vulcanization accelerator/the sulfenamide-based vulcanization accelerator being from 0.20 to 0.60. Also a conveyor belt is produced by using the rubber composition.

### TECHNICAL FIELD

The present invention relates to a rubber composition and a conveyor belt.

### BACKGROUND ART

In the related art, a rubber composition for a conveyor belt has been proposed to obtain a conveyor belt having excellent low loss property while high strength and high flame retardancy as a rubber article are maintained. The rubber composition contains a rubber component containing a natural rubber and a butadiene rubber, a vulcanizing agent, a vulcanization accelerator, carbon black, a chlorinated paraffin, and antimony trioxide, and a ratio of a content of the natural rubber to a content of the butadiene rubber (content of natural rubber:content of butadiene rubber) in terms of a mass ratio is from 25:75 to 45:55 (Patent Document 1).

### CITATION LIST

### Patent Literature

Patent Document 1: WO 2016/056219

### SUMMARY OF INVENTION

### Technical Problem

Meanwhile, in addition to the flame retardancy of a cured product obtained by curing the rubber composition described above, a rubber composition for a conveyor belt is required to have excellent processability of the rubber composition from the perspective of preventing rubber scorch, an appropriate range of vulcanization rate of the rubber composition from the perspective of achieving excellent processability of a rubber product, and excellent wear resistance of a cured product obtained by curing the rubber composition described above.

When the present inventor studied the rubber composition described in Patent Document 1, it was found that the rubber composition described above may have poor processability of the rubber composition, poor vulcanization rate of the rubber composition, or poor wear resistance or flame retardancy of a cured product obtained by curing the rubber composition.

Note that, in the present specification, processability of a rubber composition from the perspective of preventing rubber scorch may be also simply referred to as “processability”. Furthermore, vulcanization rate of a rubber composition is also simply referred to as “vulcanization rate”. Wear resistance of a cured product obtained by curing a rubber composition is also simply referred to as “wear resistance”. Flame retardancy of a cured product obtained by curing a rubber composition is also simply referred to as “flame retardancy”.

An object of the present invention is to provide a rubber composition that can set a vulcanization rate to an appropriate range while excellent wear resistance and flame retardancy are provided in a compatible manner and that achieves excellent processability.

Furthermore, another object of the present invention is to provide a conveyor belt.

### Solution to Problem

As a result of diligent study to solve the problems described above, the present inventor found that the problems described above can be solved by a rubber composition containing: a diene rubber containing a natural rubber and a butadiene rubber; a flame retardant containing a chlorinated paraffin and antimony trioxide; carbon black; sulfur; and a vulcanization accelerator containing a sulfenamide-based vulcanization accelerator and a guanidine-based vulcanization accelerator, in which a content of the natural rubber, a content of the butadiene rubber, a content of the chlorinated paraffin, a content of the antimony trioxide, a mass ratio of (a total of a content of the sulfenamide-based vulcanization accelerator and a content of the guanidine-based vulcanization accelerator)/(a content of the sulfur), and a mass ratio of (the content of the guanidine-based vulcanization accelerator)/(the content of the sulfenamide-based vulcanization accelerator) are each in a predetermined range.

That is, specifically, the present invention is to solve the problems described above by the following configurations.

[1] A rubber composition containing: a diene rubber containing a natural rubber and a butadiene rubber; a flame retardant containing a chlorinated paraffin and antimony trioxide; carbon black; sulfur; and a vulcanization accelerator containing a sulfenamide-based vulcanization accelerator and a guanidine-based vulcanization accelerator;
a content of the natural rubber being from 20 to 50 mass % with respect to a total amount of the diene rubber;
a content of the butadiene rubber being from 50 to 80 mass % with respect to the total amount of the diene rubber;
a content of the chlorinated paraffin being from 20 to 35 parts by mass per 100 parts by mass of the diene rubber;
a content of the antimony trioxide being from 5 to 12 parts by mass per 100 parts by mass of the diene rubber;
a mass ratio of (a total of a content of the sulfenamide-based vulcanization accelerator and a content of the guanidine-based vulcanization accelerator)/(a content of the sulfur) being 1.00 or more; and
a mass ratio of (the content of the guanidine-based vulcanization accelerator)/(the content of the sulfenamide-based vulcanization accelerator) being from 0.20 to 0.60.

[2] The rubber composition according to [1], where
the content of the natural rubber is from 25 to 45 mass % with respect to the total amount of the diene rubber, and
the content of the butadiene rubber is from 55 to 75 mass % with respect to the total amount of the diene rubber.

[3] The rubber composition according to [1] or [2], where the carbon black contains a carbon black 1 having a nitrogen adsorption specific surface area of more than 100 m²/g and a dibutyl phthalate oil absorption number of 100 to 140 cm³/100 g.

[4] The rubber composition according to any one of [1] to [3], where
the content of the chlorinated paraffin is from 20 to 30 parts by mass per 100 parts by mass of the diene rubber, and
the content of the antimony trioxide is from 5 to 10 parts by mass per 100 parts by mass of the diene rubber.

[5] The rubber composition according to any one of [1] to [4], where the rubber composition is for a conveyor belt.

[6] A conveyor belt produced by using the rubber composition according to any one of [1] to [5].

### Advantageous Effects of Invention

According to the present invention, a rubber composition that can set a vulcanization rate to an appropriate range while excellent wear resistance and flame retardancy are provided in a compatible manner and that achieves excellent processability can be provided.

The present invention also provides a conveyor belt.

### BRIEF DESCRIPTION OF DRAWINGS

FIG. 1 is a cross-sectional view of a conveyor belt of an embodiment of the present invention.

FIG. 2 is a cross-sectional view of a conveyor belt of another embodiment of the present invention.

### DESCRIPTION OF EMBODIMENTS

The present invention is described in detail below.

Although the components described below may be described based on representative embodiments of the present invention, the present invention is not limited to such embodiments.

In the present specification, a numerical range indicated using “(from) . . . to . . . ” includes the former number as the lower limit value and the latter number as the upper limit value.

In the present specification, each component can use a single component alone, or a combination of two or more types.

In the present specification, in a case where a component uses a combination of two or more types, a “content” of the component means a total content of these two or more types unless otherwise noted.

In the present specification, the production method of each of the components is not particularly limited unless otherwise noted. Examples of the method include a known method.

In the present specification, setting wear resistance, flame retardancy, and vulcanization rate to appropriate ranges, and at least one of processability being superior are also referred to as “achieving superior effects of the present invention”.

### Rubber Composition

The rubber composition according to an embodiment of the present invention will be described below.

The rubber composition of an embodiment of the present invention is
a rubber composition containing: a diene rubber containing a natural rubber and a butadiene rubber; a flame retardant containing a chlorinated paraffin and antimony trioxide; carbon black; sulfur; and a vulcanization accelerator containing a sulfenamide-based vulcanization accelerator and a guanidine-based vulcanization accelerator;
a content of the natural rubber being from 20 to 50 mass % with respect to a total amount of the diene rubber;
a content of the butadiene rubber being from 50 to 80 mass % with respect to the total amount of the diene rubber;
a content of the chlorinated paraffin being from 20 to 35 parts by mass per 100 parts by mass of the diene rubber;
a content of the antimony trioxide being from 5 to 12 parts by mass per 100 parts by mass of the diene rubber;
a mass ratio of (a total of a content of the sulfenamide-based vulcanization accelerator and a content of the guanidine-based vulcanization accelerator)/(a content of the sulfur) being 1.00 or more; and
a mass ratio of (the content of the guanidine-based vulcanization accelerator)/(the content of the sulfenamide-based vulcanization accelerator) being from 0.20 to 0.60.

### Diene Rubber

The rubber composition of an embodiment of the present invention contains a diene rubber containing a natural rubber and a butadiene rubber.

In an embodiment of the present invention, the diene rubber contained as a rubber component is a polymer formed by a monomer containing a conjugated diene compound.

In an embodiment of the present invention, the diene rubber contains a natural rubber and a butadiene rubber.

### Natural Rubber

In an embodiment of the present invention, the natural rubber (NR) contained as the diene rubber is not particularly limited. Examples thereof include known ones.

### Butadiene Rubber

In an embodiment of the present invention, the butadiene rubber (BR) contained as the diene rubber is not particularly limited. Examples thereof include known ones.

An example of a preferable aspect is one in which the BR is a polybutadiene that is solid at 23° C. Furthermore, the BR may be an unmodified BR or a modified BR.

The weight average molecular weight of the BR can be 200000 to 1000000.

In the present specification, the weight average molecular weight (Mw) of the BR can be a value obtained by gel permeation chromatography (GPC) measurement calibrated with polystyrene standards under the following conditions.
Solvent: Tetrahydrofuran
Detector: RI detector

### Content of Natural Rubber

In an embodiment of the present invention, the content of the natural rubber is from 20 to 50 mass % with respect to the total amount of the diene rubber described above.

From the perspective of achieving superior effects of the present invention, the content of the natural rubber is preferably from 25 to 45 mass % with respect to the total amount of the diene rubber described above.

### Content of Butadiene Rubber

In an embodiment of the present invention, the content of the butadiene rubber is from 50 to 80 mass % with respect to the total amount of the diene rubber described above.

From the perspective of achieving superior effects of the present invention, the content of the butadiene rubber is preferably from 55 to 75 mass % with respect to the total amount of the diene rubber described above.

### Total Content of Natural Rubber and Butadiene Rubber

The total content of the natural rubber and the butadiene rubber may be from 70 to 100 mass % with respect to the total amount of the diene rubber described above.

An example of a preferable aspect is one in which the diene rubber described above only contains the natural rubber and the butadiene rubber.

In a case where the total content of the natural rubber and the butadiene rubber is less than 100 mass % with respect to the total amount of the diene rubber described above, an additional diene rubber that can be further contained in the diene rubber besides the natural rubber and the butadiene rubber is not particularly limited.

### Total Content of Diene Rubber

The content of the diene rubber can be from 30 to 80 mass % with respect to the total amount of the rubber composition of an embodiment of the present invention.

### Flame Retardant

The rubber composition of an embodiment of the present invention contains a flame retardant containing a chlorinated paraffin and antimony trioxide.

### Chlorinated Paraffin

In an embodiment of the present invention, the chlorinated paraffin contained as the flame retardant is a paraffin containing chlorine.

### Proportion of Chlorine in Chlorinated Paraffin

The proportion of the chlorine in the chlorinated paraffin is not particularly limited, and from the perspective of achieving superior effects (especially, flame retardancy) of the present invention, the proportion is preferably from 40 to 90 mass %, and more preferably from 60 to 90 mass %, in the chlorinated paraffin.

### Content of Chlorinated Paraffin

In an embodiment of the present invention, the content of the chlorinated paraffin is from 20 to 35 parts by mass per 100 parts by mass of the diene rubber described above.

From the perspective of achieving superior effects of the present invention, the content of the chlorinated paraffin is preferably from 20 to 30 parts by mass per 100 parts by mass of the diene rubber described above.

### Antimony Trioxide

In an embodiment of the present invention, the antimony trioxide (Sb₂O₃) contained as the flame retardant is not particularly limited.

### Content of Antimony Trioxide

In an embodiment of the present invention, the content of the antimony trioxide is from 5 to 12 parts by mass per 100 parts by mass of the diene rubber described above.

From the perspective of achieving superior effects of the present invention, the content of the antimony trioxide is preferably from 5 to 10 parts by mass per 100 parts by mass of the diene rubber described above.

### Carbon Black

The rubber composition of an embodiment of the present invention contains carbon black.

The carbon black is not particularly limited. Examples thereof include ISAF grade carbon black and HAF grade carbon black.

### Carbon Black 1

From the perspective of achieving superior effects of the present invention, the carbon black preferably contains a carbon black 1 having a nitrogen adsorption specific surface area of more than 100 m²/g and a dibutyl phthalate oil absorption number of 100 to 140 cm³/100 g, and more preferably contains an ISAF grade carbon black. The upper limit of the nitrogen adsorption specific surface area of the carbon black 1 can be 130 m²/g or less.

The nitrogen adsorption specific surface area (N₂SA) of the carbon black can be measured in accordance with JIS K 6217-2:2017.

The dibutyl phthalate oil absorption number (DBP) of the carbon black can be measured in accordance with JIS K 6217-4:2017.

### Content of Carbon Black

From the perspective of achieving superior effects (especially, initial wear resistance, and maintenance of physical properties after aging) of the present invention, the content of the carbon black is preferably from 40 to 60 parts by mass per 100 parts by mass of the diene rubber described above.

In a case where the carbon black contains the carbon black 1 described above, the content of the carbon black 1 described above may be at least a part of the content of the carbon black described above, or the total amount of the carbon black may be the carbon black 1 described above.

### Sulfur

The rubber composition of an embodiment of the present invention contains sulfur.

The sulfur is not particularly limited as long as the sulfur is a sulfur used for vulcanization of a rubber. For example, known ones can be used.

### Content of Sulfur

From the perspective of achieving superior effects of the present invention, the content of the sulfur is preferably from 0.5 to 3.0 parts by mass, more preferably from 1.1 to 1.5 parts by mass, and even more preferably from 1.2 to 1.4 parts by mass, per 100 parts by mass of the diene rubber described above. Note that the content of the sulfur refers to a net amount of the sulfur.

### Vulcanization Accelerator

The rubber composition of an embodiment of the present invention contains a vulcanization accelerator containing a sulfenamide-based vulcanization accelerator and a guanidine-based vulcanization accelerator.

### Sulfenamide-Based Vulcanization Accelerator

The sulfenamide-based vulcanization accelerator is a compound having a sulfenamide backbone (e.g., —S—NH—) and being able to accelerate sulfur vulcanization.

Examples of the sulfenamide-based vulcanization accelerator include N-cyclohexyl-2-benzothiazolesulfenamide, N-(tert-butyl)-2-benzothiazolesulfenamide, N-oxydiethylene-2-benzothiazolesulfenamide, and N,N-dicyclohexyl-2-benzothiazolesulfenamide.

From the perspective of achieving superior effects of the present invention, the sulfenamide-based vulcanization accelerator preferably contains an N-alkyl-2-benzothiazolylsulfenamide, and more preferably contains N-(tert-butyl)-2-benzothiazolylsulfenamide.

### Sulfenamide-Based Vulcanization Accelerator Content

From the perspective of achieving superior effects of the present invention, the content of the sulfenamide-based vulcanization accelerator is preferably from 1.0 to 1.5 parts by mass, and more preferably from 1.05 to 1.15 parts by mass, per 100 parts by mass of the diene rubber described above.

### Guanidine-Based Vulcanization Accelerator

The guanidine-based vulcanization accelerator is a compound having a guanidine backbone (e.g., —NH—C(═NH)—NH—) and being able to accelerate sulfur vulcanization.

Examples of the guanidine-based vulcanization accelerator include diphenylguanidine and tolylguanidine.

From the perspective of achieving superior effects of the present invention, the guanidine-based vulcanization accelerator preferably contains diphenylguanidine, and more preferably contains 1,3-diphenylguanidine.

### Content of Guanidine-Based Vulcanization Accelerator

From the perspective of achieving superior effects of the present invention, the content of the guanidine-based vulcanization accelerator is preferably from 0.20 to 0.70 parts by mass, and more preferably from 0.35 to 0.44 parts by mass, per 100 parts by mass of the diene rubber described above.

### Mass Ratio of (Total of Content of Sulfenamide-Based Vulcanization Accelerator and Content of Guanidine-Based Vulcanization Accelerator)/(Content of Sulfur)

In an embodiment of the present invention, the mass ratio of (total of content of the sulfenamide-based vulcanization accelerator described above and content of the guanidine-based vulcanization accelerator described above)/(content of the sulfur described above) is 1.00 or more.

In the mass ratio described above, the “content of the sulfenamide-based vulcanization accelerator described above” is a content of the sulfenamide-based vulcanization accelerator per 100 parts by mass of the diene rubber described above.

In the mass ratio described above, the “content of the guanidine-based vulcanization accelerator described above” is a content of the guanidine-based vulcanization accelerator per 100 parts by mass of the diene rubber described above.

In the mass ratio described above, the “content of the sulfur described above” is a content of the sulfur per 100 parts by mass of the diene rubber described above.

From the perspective of achieving superior effects of the present invention, the mass ratio of (total of content of the sulfenamide-based vulcanization accelerator described above and content of the guanidine-based vulcanization accelerator described above)/(content of the sulfur described above) is preferably from 1.00 to 2.00, and more preferably from 1.00 to 1.60.

### Mass Ratio of (Content of Guanidine-Based Vulcanization Accelerator)/(Content of Sulfenamide-Based Vulcanization Accelerator)

In an embodiment of the present invention, the mass ratio of (content of the guanidine-based vulcanization accelerator described above)/(content of the sulfenamide-based vulcanization accelerator described above) is from 0.20 to 0.60.

In the mass ratio described above, the “content of the sulfenamide-based vulcanization accelerator described above” is a content of the sulfenamide-based vulcanization accelerator per 100 parts by mass of the diene rubber described above.

In the mass ratio described above, the “content of the guanidine-based vulcanization accelerator described above” is a content of the guanidine-based vulcanization accelerator per 100 parts by mass of the diene rubber described above.

From the perspective of achieving superior effects of the present invention, the mass ratio of (content of the guanidine-based vulcanization accelerator described above)/(content of the sulfenamide-based vulcanization accelerator described above) is preferably from 0.25 to 0.55, and more preferably from 0.30 to 0.40.

### Total of Content of Sulfenamide-Based Vulcanization Accelerator and Content of Guanidine-Based Vulcanization Accelerator

The total of the content of the sulfenamide-based vulcanization accelerator and the content of the guanidine-based vulcanization accelerator can be from 80 to 100 mass % with respect to the total amount of the vulcanization accelerator described above.

An example of a preferable aspect is one in which the vulcanization accelerator described above contains only the sulfenamide-based vulcanization accelerator and the guanidine-based vulcanization accelerator.

In a case where the total of the content of the sulfenamide-based vulcanization accelerator and the content of the guanidine-based vulcanization accelerator is less than 100 mass % with respect to the total amount of the vulcanization accelerator described above, a vulcanization accelerator that can be further contained in the vulcanization accelerator besides the sulfenamide-based vulcanization accelerator and the guanidine-based vulcanization accelerator (additional vulcanization accelerator) is not particularly limited.

### Additional Vulcanization Accelerator

Examples of the additional vulcanization accelerator described above include a thiuram-based vulcanization accelerator such as tetrakis(2-ethylhexyl)thiuram disulfide; and a sulfide-based vulcanization accelerator such as dibenzothiazole disulfide (DM) and 4,4′-dithiomorpholine.

### Anti-Aging Agent

The rubber composition of an embodiment of the present invention preferably further contains an anti-aging agent.

The anti-aging agent does not include the amine-based compound described above.

The anti-aging agent is not particularly limited and preferably contains an amine-based anti-aging agent, and more preferably contains N-(1,3-dimethylbutyl)-N′-phenyl-p-phenylenediamine (6C).

The content of the anti-aging agent is preferably from 0.5 to 8.0 parts by mass per 100 parts by mass of the diene rubber described above.

### Additives

The rubber composition of an embodiment of the present invention can further contain an additive besides the components described above. Examples of the additive include wax, zinc oxide, stearic acid, an oil, and a vulcanization retarder (e.g., N-cyclohexylthiophthalimide).

### Production Method

The method of producing the rubber composition of an embodiment of the present invention is not particularly limited. An example thereof is a method of mixing the essential components described above and an additive that can be further used as necessary at 90 to 180° C. by using a Banbury mixer or the like.

### Curing

The curing (vulcanization) of the rubber composition of an embodiment of the present invention can be performed under conditions typically employed. The curing temperature can be, for example, from 120 to 180° C. At the time of curing, pressure may be applied.

### Application

Examples of the use of the rubber composition of an embodiment of the present invention include a rubber composition for a conveyor belt.

### Cured Product

A cured product obtained by curing the rubber composition of an embodiment of the present invention can set a vulcanization rate to an appropriate range while excellent wear resistance and flame retardancy are provided in a compatible manner, and achieves excellent processability.

### Application

Examples of the use of the cured product described above include a conveyor belt.

### Conveyor Belt

The conveyor belt of an embodiment of the present invention is a conveyor belt produced by using the rubber composition of an embodiment of the present invention.

Because the conveyor belt of an embodiment of the present invention is produced by using the rubber composition of an embodiment of the present invention, a vulcanization rate can be set to an appropriate range while excellent wear resistance and flame retardancy are provided in a compatible manner, and excellent processability is achieved.

### Rubber Composition

The rubber composition used in the conveyor belt of an embodiment of the present invention is not particularly limited as long as the rubber composition is the rubber composition of an embodiment of the present invention.

The conveyor belt of an embodiment of the present invention is not particularly limited besides that the conveyor belt is produced by using the rubber composition of an embodiment of the present invention.

The rubber composition of an embodiment of the present invention can be applied to any constituent members constituting the conveyor belt of an embodiment of the present invention without particular limitation. All or a part of a rubber constituting the conveyor belt of an embodiment of the present invention can be produced by the rubber composition of an embodiment of the present invention.

An example of a preferable aspect is one in which the conveyor belt of an embodiment of the present invention has a cover rubber made of the rubber composition of an embodiment of the present invention because the rubber composition of an embodiment of the present invention can set a vulcanization rate to an appropriate range while excellent wear resistance and flame retardancy are provided in a compatible manner and achieves excellent processability.

A conveyor belt of an embodiment of the present invention will be described below using an attached drawing. However, the present invention is not limited by the attached drawings.

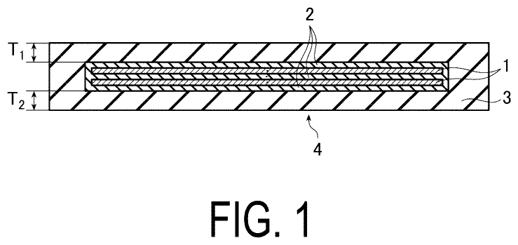

FIG. 1 is a cross-sectional view of a conveyor belt of an embodiment of the present invention. The conveyor belt of an embodiment of the present invention illustrated in FIG. 1 (herein, also referred to as a conveyor belt of a first embodiment of the present invention) is a conveyor belt 4 obtained by covering fabric layers 1 with a coating rubber (adhesive rubber) 2 to form a core material layer and covering the periphery of the core material layer with a cover rubber 3. The cover rubber 3 is preferably made of the rubber composition of an embodiment of the present invention.

In FIG. 1, the conveyor belt 4 includes the fabric layers 1 as core materials, and the number of layers of the fabric layers 1, the thickness of the cover rubber 3, the belt width, and the like can be set as appropriate depending on the purpose of use.

Examples of the fabric layer include canvas made of woven fabric of synthetic fibers such as nylon, vinylon, and polyester.

The thickness T₁ and T₂ of the cover rubber 3 can each be approximately 1.5 to 20 mm in typical cases.

Furthermore, as the coating rubber 2, a coating rubber that is used for a known conveyor belt can be used. As the coating rubber described above, for example, a rubber composition containing a natural rubber (NR), an acrylonitrile-butadiene rubber (NBR), a styrene-butadiene copolymer rubber (SBR), a butadiene rubber (BR), an ethylene-propylene rubber (EPT), or an ethylene-propylene-diene rubber (EPDM) as a rubber component can be used.

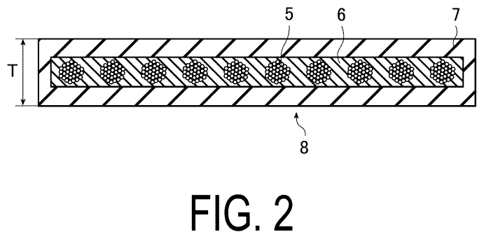

Next, a conveyor belt of a second embodiment of the present invention will be described using FIG. 2.

FIG. 2 is a cross-sectional view of a conveyor belt of another embodiment of the present invention.

As illustrated in FIG. 2, the conveyor belt of the second embodiment of the present invention is a conveyor belt 8 obtained by covering steel cords 5 with a cushion rubber (adhesive rubber) 6 to form a core material layer and covering the periphery of the core material layer with a cover rubber 7. The cover rubber 7 is preferably made of the rubber composition of an embodiment of the present invention.

In the conveyor belt 8, for example, approximately 50 to 230 steel cords 5 each having a diameter of approximately 2.0 to 9.5 mm and arranged side by side can be a core material, and each of the steel cords 5 is obtained by intertwining a plurality of wire strands each having a diameter of approximately 0.2 to 0.4 mm. In general, the total thickness T of the conveyor belt 8 can be approximately from 10 to 50 mm.

Furthermore, as the cushion rubber 6, for example, an adhesive rubber that can adhere to a zinc-plated steel cord used for a known steel conveyor belt can be used. Specifically, for example, as the cushion rubber, a rubber composition containing a natural rubber (NR), an acrylonitrile-butadiene rubber (NBR), a styrene-butadiene copolymer rubber (SBR), or a butadiene rubber (BR) as a rubber component can be used.

For example, the conveyor belt of an embodiment of the present invention can be produced by, for example, interposing a fabric layer, a steel cord, a core material layer, or the like that serves as a core material in between unvulcanized rubber sheets obtained by molding the rubber composition of an embodiment of the present invention, and performing vulcanization by heating and pressurizing, in accordance with an ordinary method. The vulcanization conditions can be, for example, approximately 120 to 180° C. and approximately 0.1 to 4.9 MPa for approximately 10 to 90 minutes.

For example, the conveyor belt of an embodiment of the present invention can be used at a temperature condition of −30 to +60° C.

### EXAMPLES

The present invention will be described in further detail below using examples.

Materials, used amounts, proportions, treatment details, treatment procedure, and the like described in the following examples can be appropriately modified without departing from the gist of an embodiment of the present invention. Thus, the scope of the present invention is not limited to the following examples.

### Production of Rubber Composition

The components listed in the tables below were used in compositions (part by mass) listed in the same tables and mixed by an agitator, and thus each of the rubber compositions was produced.

The amount listed in the row of Sulfur* in each table indicates the used amount as a commercially available product of sulfur. The same applies to the row of guanidine-based vulcanization accelerator 2 (DOPD)* and the row of thiazole-based vulcanization accelerator* (Comparative, DM).

The value listed in the mass ratio row of (Sulfenamide-based+guanidine-based vulcanization accelerators)/sulfur in each table was calculated as net amounts of the sulfur, the sulfenamide-based vulcanization accelerator, and the guanidine-based vulcanization accelerator. The same applies to values listed in the mass ratio rows of the sulfenamide-based vulcanization accelerator/the guanidine-based vulcanization accelerator/the sulfur.

### Evaluation

The following evaluations were performed by using each of the rubber compositions produced as described above. The results are shown in Table 1.

### Mooney Scorch Time at 125° C.

### Measurement of Mooney Scorch Time

In accordance with Mooney scorch test method of JIS K 6300-1:2013 “Rubber, unvulcanized-Physical property-Part 1: Determination of Mooney viscosity and pre-vulcanization characteristics with Mooney viscometer”, Mooney minimum viscosity (MIN torque) and Mooney scorch time at 125° C. were measured using a Mooney viscometer (L-shaped rotor) for each of the (unvulcanized) rubber compositions produced as described above. For the Mooney scorch time, time required for increase by 5 Mooney from the MIN torque (ML-5 up; unit: minute) was listed on the row of Mooney scorch time (min) at 125° C. of each table.

### Evaluation Criteria for Processability

In an embodiment of the present invention, a case where the Mooney scorch time measured as described above was 25.0 to 35.0 minutes was evaluated as achieving excellent processability. A case where the Mooney scorch time is in the range described above is preferred because rubber scorch is less likely to occur.

In a case where the Mooney scorch time is from 25.0 to 35.0 minutes, a longer Mooney scorch time is more preferred because the rubber scorch is even less likely to occur.

### Vulcanization Time

### Measurement of Each Vulcanization Time T

In accordance with JIS K 6300-2:2001 “Rubber, unvulcanized-Physical property-Part 2: Determination of cure characteristics with oscillating curemeters”, a torque of each of the (unvulcanized) rubber compositions produced as described above was measured at 148° C. by using a rotorless curemeter as a rheometer. A vulcanization curve having the torque obtained as described above as a vertical axis and a vulcanization time (minute) as a horizontal axis was created, and a maximum value MH and a minimum value ML of the torque were obtained from the vulcanization curve described above.

A difference between the maximum value MH and the minimum value ML obtained as described above is taken as ME.

The time at which the torque of ML+ME×0.05 was reached (time (minute) for the torque measured by the oscillating curemeter described above to reach 5% of the difference ME between the maximum value MH and the minimum value ML of the torque in the vulcanization curve described above from the start of the vulcanization) was taken as T5.

The time at which the torque of ML+ME×0.30 was reached was taken as T30 (time (minute) for the torque measured by the oscillating curemeter described above to reach 30% of the difference ME between the maximum value MH and the minimum value ML of the torque in the vulcanization curve described above from the start of the vulcanization).

The time at which the torque of ML+ME×0.70 was reached was taken as T70 (time (minute) for the torque measured by the oscillating curemeter described above to reach 70% of the difference ME between the maximum value MH and the minimum value ML of the torque in the vulcanization curve described above from the start of the vulcanization).

The time at which the torque of ML+ME×0.95 was reached was taken as T95 (time (minute) for the torque measured by the oscillating curemeter described above to reach 95% of the difference ME between the maximum value MH and the minimum value ML of the torque in the vulcanization curve described above from the start of the vulcanization).

### T70−T30

T70 and T30 obtained as described above were substituted into “T70−T30”.

### T95−T5

T95 and T5 obtained as described above were substituted into “T95−T5”.

### Evaluation Criteria of Vulcanization Rate

In an embodiment of the present invention, a case where the value of T70−T30 obtained as described above satisfied Expression (1): 3.0≤(T70−T30)≤3.5 and the value of T95−T5 obtained as described above satisfied Expression (2): 15.0≤(T95−T5)≤18.0 was evaluated as achieving an appropriate range of vulcanization rate. A case where the vulcanization rate is in an appropriate range is preferred because excellent productivity of the resulting rubber product is achieved.

A case where the value of T70−T30 was closer to 3.0 and/or a case where the value of T95−T5 was closer to 15.0 was evaluated as achieving more appropriate vulcanization rate.

### Wear Resistance

### Preparation of Vulcanization Test Sample

Using a press molding machine at 148° C., each of the rubber compositions produced as described above was vulcanized for 30 minutes under a surface pressure of 3.0 MPa, and thus a vulcanization test sample having a diameter of 16 mm and a thickness of 6 mm was prepared.

### DIN Abrasion Test

In accordance with JIS K 6264-2:2005, using each of the vulcanization test samples prepared as described above, DIN abrasion test (method A: non-rotating method by which the test sample was not rotated) was performed at 23° C. using a DIN abrasion tester under conditions including the rotation speed of a drum of the DIN abrasion tester of 40 rpm and a load of 9.8 N, and thus an amount of wear [mm³] was measured.

A case where the amount of wear measured as described above was 40 mm³ or less was indicated as “Excellent”.

A case where the amount of wear measured as described above was more than 40 mm³ and 70 mm³ or less was indicated as “Good”.

A case where the amount of wear measured as described above was more than 70 mm³ was indicated as “Poor”.

### Evaluation Criteria of Wear Resistance

In an embodiment of the present invention, a case where the amount of wear measured as described above was 70 mm³ or less was evaluated as achieving excellent wear resistance.

A smaller value of the amount of wear described above of less than 70 mm³ indicates superior wear resistance.

### Flame Retardancy

### Preparation of Test Piece

Test pieces (3 test pieces of each type) were prepared by using each of the rubber compositions produced as described above in accordance with 7.2.1 Fabric Layer Conveyor Rubber of JIS K 6324:2013 “Flame resistant conveyor belts-Classification and test method”. For the vulcanization during production described above, test pieces were prepared by vulcanization under typical vulcanization conditions at a surface pressure of 3.0 MPa for 30 minutes by using a press molding machine at 148° C.

### Evaluation Method of Flame Retardancy

For the test pieces prepared as described above, duration (unit: second) of flame was measured in accordance with JIS K 6324:2013 “Flame resistant conveyor belts-Classification and test method”.

### Evaluation Criteria of Flame Retardancy

In an embodiment of the present invention, a case where the test pieces described above satisfied flame retardancy test standard of JIS grade 3 [duration of flame was within 1 minute (the duration of flame was an average value of the three test pieces), no recombustion] was evaluated as achieving excellent flame retardancy, and this was indicated as “Good”.

A case where the test pieces described above did not satisfy flame retardancy test standard of JIS grade 3 was evaluated as having poor flame retardancy, and this was indicated as “Poor”.

TABLE 1
Table 1

| | | Example | Example | Example | Example | Example | Example | Example | Example | Example |
|---|---|---|---|---|---|---|---|---|---|---|
| | | 1 | 2 | 3 | 4 | 5 | 6 | 7 | 8 | 9 |
| Diene rubber | NR | 35.00 | 35.00 | 35.00 | 35.00 | 35.00 | 35.00 | 35.00 | 20.00 | 50.00 |
| | BR | 65.00 | 65.00 | 65.00 | 65.00 | 65.00 | 65.00 | 65.00 | 80.00 | 50.00 |
| Carbon black | CB (ISAF) | 60.00 | 60.00 | 60.00 | 60.00 | 60.00 | 60.00 | 60.00 | 60.00 | 60.00 |
| | CB (HAF) | | | | | | | | | |
| Flame retardant | Chlorinated | 25.00 | 25.00 | 25.00 | 25.00 | 25.00 | 25.00 | 25.00 | 25.00 | 25.00 |
| | paraffin | | | | | | | | | |
| | Antimony | 7.50 | 7.50 | 7.50 | 7.50 | 7.50 | 7.50 | 7.50 | 7.50 | 7.50 |
| | trioxide | | | | | | | | | |
| Anti-aging agent (6C) | | 2.50 | 2.50 | 2.50 | 2.50 | 2.50 | 2.50 | 2.50 | 2.50 | 2.50 |
| Wax | | 2.00 | 2.00 | 2.00 | 2.00 | 2.00 | 2.00 | 2.00 | 2.00 | 2.00 |
| Zinc oxide | | 3.00 | 3.00 | 3.00 | 3.00 | 3.00 | 3.00 | 3.00 | 3.00 | 3.00 |
| Stearic acid | | 1.00 | 1.00 | 1.00 | 1.00 | 1.00 | 1.00 | 1.00 | 1.00 | 1.00 |
| Sulfur* | | 1.40 | 1.40 | 1.40 | 1.40 | 1.40 | 1.40 | 1.40 | 1.40 | 1.40 |
| Sulfenamide-based vulcanization | | | | | | | 1.10 | | | |
| accelerator 1 (CZ) | | | | | | | | | | |
| Sulfenamide-based vulcanization | | 1.10 | 1.10 | 1.10 | 1.10 | 1.00 | | 1.10 | 1.10 | 1.10 |
| accelerator 2 (NS) | | | | | | | | | | |
| Guanidine-based vulcanization | | 0.40 | 0.25 | 0.30 | 0.50 | 0.60 | 0.40 | | 0.40 | 0.40 |
| accelerator 1 (DPG) | | | | | | | | | | |
| Guanidine-based vulcanization | | | | | | | | 0.40 | | |
| accelerator 2 (DOPG)* | | | | | | | | | | |
| Thiuram-based vulcanization | | | | | | | | | | |
| accelerator (Comparative, TMTM) | | | | | | | | | | |
| Thiazole-based vulcanization | | | | | | | | | | |
| accelerator* (Comparative, DM) | | | | | | | | | | |
| Mass ratio of (sulfenamide- | | 1.12 | 1.01 | 1.05 | 1.20 | 1.20 | 1.12 | 1.11 | 1.12 | 1.12 |
| based + guanidine-based | | | | | | | | | | |
| vulcanization accelerators)/ | | | | | | | | | | |
| sulfur | | | | | | | | | | |
| Mass ratio of guanidine-based | | 0.36 | 0.23 | 0.27 | 0.45 | 0.60 | 0.36 | 0.35 | 0.36 | 0.36 |
| vulcanization accelerator/ | | | | | | | | | | |
| sulfenamide-based vulcanization | | | | | | | | | | |
| accelerator | | | | | | | | | | |
| Mooney scorch time (minute) at | | 29.9 | 32.3 | 31.7 | 28.5 | 27.4 | 27.3 | 32.8 | 29.8 | 28.2 |
| 125° C. | | | | | | | | | | |
| Expression (1) | T70-T30 was | 3.2 | 3.4 | 3.4 | 3.0 | 3.3 | 3.5 | 3.4 | 3.5 | 3.0 |
| | 3.0 to 3.5 | | | | | | | | | |
| Expression (2) | T95-T5 was | 15.6 | 16.8 | 16.5 | 15.1 | 16.4 | 16.9 | 16.7 | 17.7 | 15.1 |
| | 15.0 to 18.0 | | | | | | | | | |
| Wear | DIN Abrasion | Excellent | Good | Good | Good | Good | Good | Good | Good | Good |
| resistance | without rotation | | | | | | | | | |
| Flame | JIS grade 3 | Good | Good | Good | Good | Good | Good | Good | Good | Good |
| retardancy | | | | | | | | | | |

TABLE 2
Table 2

| | | Example | Example | Example | Example | Example | Example | Example | Example |
|---|---|---|---|---|---|---|---|---|---|
| | | 10 | 11 | 12 | 13 | 14 | 15 | 16 | 17 |
| Diene rubber | NR | 35.00 | 35.00 | 35.00 | 35.00 | 35.00 | 35.00 | 35.00 | 35.00 |
| | BR | 65.00 | 65.00 | 65.00 | 65.00 | 65.00 | 65.00 | 65.00 | 65.00 |
| Carbon black | CB (ISAF) | 60.00 | 60.00 | | 60.00 | 60.00 | 60.00 | 60.00 | 60.00 |
| | CB (HAF) | | | 60.00 | | | | | |
| Flame retardant | Chlorinated | 20.00 | 35.00 | 25.00 | 25.00 | 25.00 | 25.00 | 25.00 | 25.00 |
| | paraffin | | | | | | | | |
| | Antimony | 12.00 | 5.00 | 7.50 | 7.50 | 7.50 | 7.50 | 7.50 | 7.50 |
| | trioxide | | | | | | | | |
| Anti-aging agent (6C) | | 2.50 | 2.50 | 2.50 | 2.50 | 2.50 | 2.50 | 2.50 | 2.50 |
| Wax | | 2.00 | 2.00 | 2.00 | 2.00 | 2.00 | 2.00 | 2.00 | 2.00 |
| Zinc oxide | | 3.00 | 3.00 | 3.00 | 3.00 | 3.00 | 3.00 | 3.00 | 3.00 |
| Stearic acid | | 1.00 | 1.00 | 1.00 | 1.00 | 1.00 | 1.00 | 1.00 | 1.00 |
| Sulfur* | | 1.40 | 1.40 | 1.40 | 1.40 | 1.40 | 1.00 | 1.20 | 1.50 |
| Sulfenamide-based vulcanization | | | | | | | | | |
| accelerator 1 (CZ) | | | | | | | | | |
| Sulfenamide-based vulcanization | | 1.10 | 1.10 | 1.10 | 1.00 | 1.20 | 1.10 | 1.10 | 1.10 |
| accelerator 2 (NS) | | | | | | | | | |
| Guanidine-based vulcanization | | 0.40 | 0.40 | 0.40 | 0.40 | 0.40 | 0.40 | 0.40 | 0.40 |
| accelerator 1 (DPG) | | | | | | | | | |
| Guanidine-based vulcanization | | | | | | | | | |
| accelerator 2 (DOPG)* | | | | | | | | | |
| Thiuram-based vulcanization | | | | | | | | | |
| accelerator (Comparative, TMTM) | | | | | | | | | |
| Thiazole-based vulcanization | | | | | | | | | |
| accelerator* (Comparative, DM) | | | | | | | | | |
| Mass ratio of (sulfenamide- | | 1.12 | 1.12 | 1.12 | 1.05 | 1.20 | 1.57 | 1.31 | 1.05 |
| based + guanidine-based | | | | | | | | | |
| vulcanization accelerators)/ | | | | | | | | | |
| sulfur | | | | | | | | | |
| Mass ratio of guanidine-based | | 0.36 | 0.36 | 0.36 | 0.40 | 0.33 | 0.36 | 0.36 | 0.36 |
| vulcanization accelerator/ | | | | | | | | | |
| sulfenamide-based vulcanization | | | | | | | | | |
| accelerator | | | | | | | | | |
| Mooney scorch time (minute) at | | 26.7 | 34.6 | 30.3 | 30.8 | 27.7 | 34.3 | 30.5 | 29.2 |
| 125° C. | | | | | | | | | |
| Expression (1) | T70-T30 was 3.0 | 3.1 | 3.5 | 3.2 | 3.4 | 3.0 | 3.5 | 3.2 | 3.1 |
| | to 3.5 | | | | | | | | |
| Expression (2) | T95-T5 was 15.0 | 15.2 | 17.8 | 15.9 | 16.8 | 15.2 | 17.8 | 16.0 | 15.3 |
| | to 18.0 | | | | | | | | |
| Wear | DIN Abrasion | Good | Good | Good | Good | Good | Good | Good | Good |
| resistance | without rotation | | | | | | | | |
| Flame | JIS grade 3 | Good | Good | Good | Good | Good | Good | Good | Good |
| retardancy | | | | | | | | | |

TABLE 3
Table 3

| | | Comparative | Comparative | Comparative | Comparative | Comparative | Comparative | Comparative | Comparative |
|---|---|---|---|---|---|---|---|---|---|
| | | Example 1 | Example 2 | Example 3 | Example 4 | Example 5 | Example 6 | Example 7 | Example 8 |
| Diene rubber | NR | 35.00 | 35.00 | 35.00 | 35.00 | 35.00 | 15.00 | 55.00 | 35.00 |
| | BR | 65.00 | 65.00 | 65.00 | 65.00 | 65.00 | 85.00 | 45.00 | 65.00 |
| Carbon black | CB (ISAF) | 60.00 | 60.00 | 60.00 | 60.00 | 60.00 | 60.00 | 60.00 | 60.00 |
| | CB (HAF) | | | | | | | | |
| Flame retardant | Chlorinated | 25.00 | 25.00 | 25.00 | 25.00 | 25.00 | 25.00 | 25.00 | 40.00 |
| | paraffin | | | | | | | | |
| | Antimony | 7.50 | 7.50 | 7.50 | 7.50 | 7.50 | 7.50 | 7.50 | 7.50 |
| | trioxide | | | | | | | | |
| Anti-aging agent (6C) | | 2.50 | 2.50 | 2.50 | 2.50 | 2.50 | 2.50 | 2.50 | 2.50 |
| Wax | | 2.00 | 2.00 | 2.00 | 2.00 | 2.00 | 2.00 | 2.00 | 2.00 |
| Zinc oxide | | 3.00 | 3.00 | 3.00 | 3.00 | 3.00 | 3.00 | 3.00 | 3.00 |
| Stearic acid | | 1.00 | 1.00 | 1.00 | 1.00 | 1.00 | 1.00 | 1.00 | 1.00 |
| Sulfur* | | 1.40 | 1.40 | 1.40 | 1.40 | 1.40 | 1.40 | 1.40 | 1.40 |
| Sulfenamide-based vulcanization | | | | | | | | | |
| accelerator 1 (CZ) | | | | | | | | | |
| Sulfenamide-based vulcanization | | 1.30 | 0.80 | 1.10 | 1.10 | 1.10 | 1.10 | 1.10 | 1.10 |
| accelerator 2 (NS) | | | | | | | | | |
| Guanidine-based vulcanization | | 0.10 | 0.20 | | | | 0.40 | 0.40 | 0.40 |
| accelerator 1 (DPG) | | | | | | | | | |
| Guanidine-based vulcanization | | | | | | | | | |
| accelerator 2 (DOPG)* | | | | | | | | | |
| Thiuram-based vulcanization | | | | 0.20 | | | | | |
| accelerator (Comparative, TMTM) | | | | | | | | | |
| Thiazole-based vulcanization | | | | | 1.00 | | | | |
| accelerator* (Comparative, DM) | | | | | | | | | |
| Mass ratio of (sulfenamide- | | 1.05 | 0.75 | 0.97 | 1.54 | 0.82 | 1.12 | 1.12 | 1.12 |
| based + guanidine-based | | | | | | | | | |
| vulcanization accelerators)/ | | | | | | | | | |
| sulfur | | | | | | | | | |
| Mass ratio of guanidine-based | | 0.08 | 0.25 | 0.00 | 0.00 | 0.00 | 0.36 | 0.36 | 0.36 |
| vulcanization accelerator/ | | | | | | | | | |
| sulfenamide-based | | | | | | | | | |
| vulcanization accelerator | | | | | | | | | |
| Mooney scorch time (minute) at | | 36.0 | 37.1 | 30.3 | 19.8 | 39.6 | 29.8 | 28.0 | 40.4 |
| 125° C. | | | | | | | | | |
| Expression (1) | T70-T30 was 3.0 | 3.1 | 5.9 | 2.0 | 2.1 | 3.9 | 4.2 | 2.7 | 6.4 |
| | to 3.5 | | | | | | | | |
| Expression (2) | T95-T5 was 15.0 | 16.1 | 26.0 | 9.8 | 14.2 | 18.9 | 20.9 | 13.9 | 29.5 |
| | to 18.0 | | | | | | | | |
| Wear | DIN Abrasion | Good | Good | Good | Good | Good | Excellent | Poor | Poor |
| resistance | without rotation | | | | | | | | |
| Flame | JIS grade 3 | Good | Good | Good | Good | Good | Poor | Good | Good |
| retardancy | | | | | | | | | |

TABLE 4
Table 4

| | | Comparative | Comparative | Comparative | Comparative | Comparative | Comparative |
|---|---|---|---|---|---|---|---|
| | | Example 9 | Example 10 | Example 11 | Example 12 | Example 13 | Example 14 |
| Diene rubber | NR | 35.00 | 35.00 | 50.00 | 35.00 | 35.00 | 35.00 |
| | BR | 65.00 | 65.00 | 50.00 | 65.00 | 65.00 | 65.00 |
| Carbon black | CB (ISAF) | 60.00 | 60.00 | 60.00 | 60.00 | 60.00 | 60.00 |
| | CB (HAF) | | | | | | |
| Flame retardant | Chlorinated | 25.00 | 25.00 | 25.00 | 25.00 | 25.00 | 25.00 |
| | paraffin | | | | | | |
| | Antimony | 7.50 | 7.50 | 7.50 | 7.50 | 7.50 | 7.50 |
| | trioxide | | | | | | |
| Anti-aging agent (6C) | | 2.50 | 2.50 | 2.50 | 2.50 | 2.50 | 2.50 |
| Wax | | 2.00 | 2.00 | 2.00 | 2.00 | 2.00 | 2.00 |
| Zinc oxide | | 3.00 | 3.00 | 3.00 | 3.00 | 3.00 | 3.00 |
| Stearic acid | | 1.00 | 1.00 | 1.00 | 1.00 | 1.00 | 1.00 |
| Sulfur* | | 1.40 | 2.0 | 2.0 | 1.70 | 1.40 | 1.40 |
| Sulfenamide-based vulcanization | | | 1 | 1 | | | |
| accelerator 1 (CZ) | | | | | | | |
| Sulfenamide-based vulcanization | | 2.20 | | | 1.10 | 1.10 | 1.10 |
| accelerator 2 (NS) | | | | | | | |
| Guanidine-based vulcanization | | 0.40 | 0.5 | 0.5 | 0.40 | 0.20 | 0.70 |
| accelerator 1 (DPG) | | | | | | | |
| Guanidine-based vulcanization | | | | | | | |
| accelerator 2 (DOPG)* | | | | | | | |
| Thiuram-based vulcanization | | | | | | | |
| accelerator (Comparative, TMTM) | | | | | | | |
| Thiazole-based vulcanization | | | | | | | |
| accelerator* (Comparative, DM) | | | | | | | |
| Mass ratio of (sulfenamide- | | 1.95 | 0.79 | 0.79 | 0.93 | 0.97 | 1.35 |
| based + guanidine-based | | | | | | | |
| vulcanization accelerators)/ | | | | | | | |
| sulfur | | | | | | | |
| Mass ratio of guanidine-based | | 0.18 | 0.5 | 0.5 | 0.36 | 0.18 | 0.64 |
| vulcanization accelerator/ | | | | | | | |
| sulfenamide-based vulcanization | | | | | | | |
| accelerator | | | | | | | |
| Mooney scorch time (minute) at | | 23.2 | 26.4 | 24.1 | 27.6 | 34.3 | 25.3 |
| 125° C. | | | | | | | |
| Expression (1) | T70-T30 was 3.0 | 2.4 | 2.9 | 2.7 | 3.1 | 3.6 | 2.8 |
| | to 3.5 | | | | | | |
| Expression (2) | T95-T5 was 15.0 | 11.9 | 14.1 | 13.5 | 14.9 | 17.9 | 14.7 |
| | to 18.0 | | | | | | |
| Wear | DIN Abrasion | Good | Good | Good | Good | Good | Good |
| resistance | without rotation | | | | | | |
| Flame | JIS grade 3 | Good | Good | Good | Good | Good | Good |
| retardancy | | | | | | | |

Details of the components listed in Tables 1 to 4 are as follows.

### Diene Rubber

NR: Natural rubber. RSS #3
BR: Butadiene rubber. Trade name: Nipol BR 1220 (available from Zeon Corporation; weight average molecular weight: 460000)

### Carbon Black

CB (ISAF): Trade name: Show Black N220, available from Cabot Japan K.K. N₂SA: 111 m²/g; DBP: 115 cm³/100 g
CB (HAF): Trade name: SEAST N, available from NSCC Carbon Co., Ltd. N₂SA: 74 m²/g; DBP: 101 cm³/100 g

### Flame Retardant

Chlorinated paraffin: (Trade name) Chlorinated Paraffin 70, available from NeimengguXihe Chemical. Average chlorine content: 70 mass %.
Antimony trioxide: (Trade name) PATOX-M, available from Nihon Seiko Co., Ltd.
Anti-aging agent (6C): Amine-based anti-aging agent. N-(1,3-dimethylbutyl)-N′-phenyl-p-phenylenediamine (following structure). Trade name: OZONONE 6C (available from Seiko Chemical Co., Ltd.)

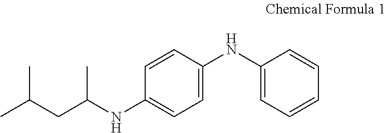 [SMILES: CC(C)CC(C)Nc1ccc(Nc2ccccc2)cc1]

Wax: Paraffin wax. Trade name: OZOACE-0037 (available from Nippon Seiro Co., Ltd.)
Zinc oxide: Trade name “Zinc Oxide III” (available from Seido Chemical Industry Co., Ltd.)
Stearic acid: Trade name “Stearic Acid 50S” (available from New Japan Chemical Co., Ltd.)

### Sulfur

Sulfur*: Oil-treated sulfur. Available from Hosoi Chemical Industry Co., Ltd. Sulfur concentration: 95.24 mass %.

### Sulfenamide-Based Vulcanization Accelerator

Sulfenamide-based vulcanization accelerator 1 (CZ): N-cyclohexyl-2-benzothiazolylsulfenamide (following structure) (trade name: NOCCELER CZ, available from Ouchi Shinko Chemical Industrial Co., Ltd.)

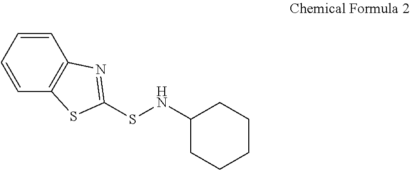 [SMILES: c1ccc2sc(SNC3CCCCC3)nc2c1]

Sulfenamide-based vulcanization accelerator 2 (NS): N-(tert-butyl)-2-benzothiazolesulfenamide (following structure) (trade name: SANCELER NS-G, available from Sanshin Chemical Industry Co., Ltd.)

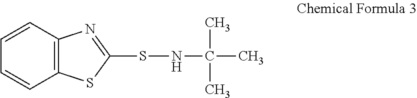

### Guanidine-Based Vulcanization Accelerator

Guanidine-based vulcanization accelerator 1 (DPG):
   Diphenylguanidine (following structure) (trade name: Soxinol D-G, available from Sumitomo Chemical Co., Ltd.)

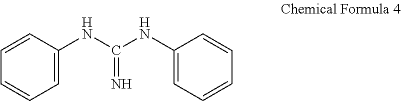 [SMILES: N=C(Nc1ccccc1)Nc1ccccc1]

Guanidine-based vulcanization accelerator 2 (DOPG)*: 1,3-Di-o-tolylguanidine (following structure) (trade name: Soxinol DT-O, available from Sumitomo Chemical Co., Ltd.); 1,3-di-o-tolylguanidine concentration: 95 mass % or more. Note that, when a net amount of 1,3-di-o-tolylguanidine contained in the commercially available product described above was calculated, the concentration of the 1,3-di-o-tolylguanidine in the commercially available product described above was taken as 95 mass %.

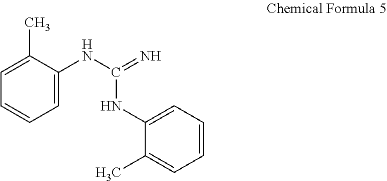 [SMILES: Cc1ccccc1NC(=N)Nc1ccccc1C]

Thiuram-based vulcanization accelerator (Comparative, TMTM): Tetramethylthiurammonosulfide (trade name: NOCCELER TS, available from Ouchi Shinko Chemical Industrial Co., Ltd.)
Thiazole-based vulcanization accelerator* (Comparative, DM): Dibenzothiazole disulfide (trade name: NOCCELER DM-PO, available from Ouchi Shinko Chemical Industrial Co., Ltd.); dibenzothiazole disulfide concentration: 95 mass % or more. Note that, when a net amount of dibenzothiazole disulfide contained in the commercially available product described above was calculated, the concentration of the dibenzothiazole disulfide in the commercially available product described above was taken as 95 mass %.

It was confirmed that the rubber compositions of embodiments of the present invention achieved the desired effects from the results of Table 1 to Table 4.

On the other hand, Comparative Examples 1 and 9 each having the mass ratio of (content of the guanidine-based vulcanization accelerator)/(content of the sulfenamide-based vulcanization accelerator) of less than the predetermined range had poor processability. Furthermore, in Comparative Example 9, the vulcanization rate was not in the appropriate range.

In Comparative Examples 2 and 10 to 12 each having the mass ratio of (total of content of the sulfenamide-based vulcanization accelerator and the content of guanidine-based vulcanization accelerator)/(content of the sulfur) of less than 1.00, the vulcanization rate was not in the appropriate range. Comparative Examples 2 and 11 also had poor processability.

In Comparative Example 3 that did not contain the guanidine-based vulcanization accelerator but contained a thiuram-based vulcanization accelerator instead, Comparative Example 4 that did not contain the guanidine-based vulcanization accelerator but contained a thiazole-based vulcanization accelerator instead, and Comparative Example 5 that did not contain the guanidine-based vulcanization accelerator, at least the vulcanization rate was not in the appropriate range. Comparative Examples 4 and 5 also had poor processability.

In Comparative Examples 6 and 7 each having the content of the natural rubber and the content of the butadiene rubber outside of the predetermined ranges, at least the vulcanization rate was not in the appropriate range.

Comparative Example 8 having the content of the chlorinated paraffin outside of the predetermined range had poor processability and wear resistance, and the vulcanization rate was not in the appropriate range.

In Comparative Example 13 having the mass ratio of (total of content of the sulfenamide-based vulcanization accelerator and content of the guanidine-based vulcanization accelerator)/(content of the sulfur) of less than 1.00 and the mass ratio of (content of the guanidine-based vulcanization accelerator)/(content of the sulfenamide-based vulcanization accelerator) outside of the predetermined range, the vulcanization rate was not in the appropriate range.

In Comparative Example 14 having the mass ratio of (content of the guanidine-based vulcanization accelerator)/(content of the sulfenamide-based vulcanization accelerator) of more than the predetermined range, the vulcanization rate was not in the appropriate range.

### REFERENCE SIGNS LIST

1: Fabric layer
2: Coating rubber
3,7: Cover rubber
4,8: Conveyor belt
5: Steel cord
6: Cushion rubber

1. A rubber composition comprising: a diene rubber containing a natural rubber and a butadiene rubber; a flame retardant containing a chlorinated paraffin and antimony trioxide; carbon black; sulfur; and a vulcanization accelerator containing a sulfenamide-based vulcanization accelerator and a guanidine-based vulcanization accelerator;
a content of the natural rubber being from 20 to 50 mass % with respect to a total amount of the diene rubber;
a content of the butadiene rubber being from 50 to 80 mass % with respect to the total amount of the diene rubber;
a content of the chlorinated paraffin being from 20 to 35 parts by mass per 100 parts by mass of the diene rubber;
a content of the antimony trioxide being from 5 to 12 parts by mass per 100 parts by mass of the diene rubber;
a mass ratio of (a total of a content of the sulfenamide-based vulcanization accelerator and a content of the guanidine-based vulcanization accelerator)/(a content of the sulfur) being 1.00 or more; and
a mass ratio of (the content of the guanidine-based vulcanization accelerator)/(the content of the sulfenamide-based vulcanization accelerator) being from 0.20 to 0.60.

2. The rubber composition according to claim 1, wherein
the content of the natural rubber is from 25 to 45 mass % with respect to the total amount of the diene rubber, and
the content of the butadiene rubber is from 55 to 75 mass % with respect to the total amount of the diene rubber.

3. The rubber composition according to claim 1, wherein the carbon black contains a carbon black 1 having a nitrogen adsorption specific surface area of more than 100 m²/g and a dibutyl phthalate oil absorption number of 100 to 140 cm³/100 g.

4. The rubber composition according to claim 1, wherein
the content of the chlorinated paraffin is from 20 to 30 parts by mass per 100 parts by mass of the diene rubber, and
the content of the antimony trioxide is from 5 to 10 parts by mass per 100 parts by mass of the diene rubber.

5. The rubber composition according to claim 1, wherein the rubber composition is for a conveyor belt.

6. A conveyor belt produced by using the rubber composition according to claim 1.
